(19) United States
(12) Patent Application Publication
(10) Pub. No.: US 2021/0019378 A1
(43) Pub. Date: Jan. 21, 2021

(54) Digital Rights Management System and Method

(71) Applicant: III Holdings 2, LLC, Wilmington, DE (US)

(72) Inventors: Raksit Ashok, Sunnyvale, CA (US); Kristopher Carver, Chicopee, MA (US); Saurabh Chedda, Santa Clara, CA (US); Jared Eldredge, Amherst, MA (US); Csaba Andras Moritz, Amherst, CA (US)

(73) Assignee: III Holdings 2, LLC, Wilmington, DE (US)

(21) Appl. No.: 16/918,685

(22) Filed: Jul. 1, 2020

Related U.S. Application Data
(63) Continuation of application No. 11/804,947, filed on May 21, 2007, now abandoned.
(60) Provisional application No. 60/802,451, filed on May 22, 2006.

(51) Int. Cl. G06F 21/10

(52) U.S. Cl. CPC G06F 21/10; G06F 2221/0728; G06F 2221/2141

(57) ABSTRACT

A method, for use in a DRM context, wherein digital rights enforcing processing is embedded into the rights object. A method, for use in a DRM context, wherein digital rights enforcing is downloaded to a device related to a content access. A processor framework, containing a VISC engine and executing digital rights enforcing codes, wherein the rights enforcing codes are downloaded. A digital rights management framework, wherein a rights enforcing code is downloaded related to a content access.

### TECHNICAL FIELD

This invention relates generally to providing digital rights management (DRM) and content protection with high security and maximum flexibility. More particularly, it relates to rights management capabilities incorporated into DRM rights objects or digital content, or downloaded in conjunction with content access, in the form of secure code snippets. It provides a mechanism for rights management to be customized for a digital content. Moreover, it relates to mechanisms for content decoding to be customized per digital content and supported on different platforms.

A key feature is that the invention can support new rights models on-demand without requiring this processing support to be available in the device before content access is initiated.

### BACKGROUND

Multimedia-enabled devices are proliferating at a rapid rate. Playing or accessing content such as ring-tones, short movies, games, news, music, and wallpapers, is increasingly supported in all kinds of mobile devices such as mobile phones, mp3 and mpeg4 players, and portable digital assistants (PDA). Additionally, enterprise digital rights management to control rights associated with enterprise documents, email, and all kind of digital information, is increasingly required.

Furthermore, many new types of devices are being created where digital media is accessed from: a recent device is the ultra-mobile-PC (UMPC).

The diversity of environments includes the types of media, the type of rights management, different operating systems supported, different standards that might need to be supported, and ability to support custom rights.

The growth potential of new applications using mobile content is huge due not only to the sheer volume of these devices already in use, but also due to the desire of consumers to have media content accessible on-the-go anywhere and at any time.

The ability to access enterprise related information on-the-go in an emerging mobile enterprise world where employees access information from computers as well as mobile devices is a becoming increasingly common.

In a typical use-case scenario, content is downloaded through a web browser or other means to a device. It can also be pushed to a device. The device can be a mobile device or other system. The key players in the mobile value chain providing content to a mobile device include mobile operators, content providers, rights issuers, certification authorities, and device manufacturers.

In some instances the rights and content delivery roles are fulfilled by the same company. In other situations the content is managed by an enterprise and content relates to information for customers or employees.

Device manufacturers typically rely on semiconductor vendors and software modules provided by third party software vendors to enable rights management in a device.

In a mobile environment, the content provider typically owns the content and passes it on to a mobile operator that would in turn relay it to handset devices through a mobile network.

Along the way, the content is encrypted and usage rights are defined in rights objects. The rights are either incorporated into separate DRM tickets or embedded into the content by a rights issuer entity.

Every DRM ticket defines content usage rights purchased by end users for a particular digital content. These rights will then be interpreted and enforced in the device.

These rights can include, for example, playing the content a small number of times (also called preview), sharing the content with friends (called super-distribution), time-limited access, expiring content, monthly subscription services, etc.

In addition to these, many new pricing and rights models are emerging, driven by new content types as well as new opportunities to make revenues. A good example of a new content type that generates good revenues is ring tones. Other types of rights management might include expiration to certain rights and not to others within same rights object, parental control, etc.

Before mobile content can be made widely available and the associated applications really materialize for consumers and the enterprise, however, the industry needs to resolve several key remaining issues related to protecting content and digital rights management as well as securing critical applications.

Security is necessary to convince content providers, or the enterprise, to make their content available. Despite opportunities to generate huge revenues for both mobile operators and content providers, content providers will remain reluctant to provide their content until adequate security is achieved and adequate flexibility is enabled.

In the enterprise, securing the enterprise DRM while providing maximum flexibility across device types, media formats, and operating systems, is paramount.

A critical aspect of any new solution is support for a variety of DRM models. Unfortunately, it is difficult to pre-build support for all the various models and it is difficult to upgrade this functionality securely after a device has been shipped to a customer.

Business models for content delivery and rights management must take into account consumers' demand for simplicity in ownership, usage and billing, ability to access the same content from different platforms and operating systems (OS); moreover, new business models are still emerging. In order to attract subscribers, or facilitate widespread usage in the enterprise of content access from a variety of mobile platforms as well as wired systems, it is critical to be able to refine rights models.

Moreover, any content protection and DRM solution must meet performance and energy-efficiency requirements. This means that the approach should not impose an unreasonable demand on processing resources and must meet quality of service requirements such as acceptable response time during media access.

While there are new standards available to provide interoperability, it is not possible to define all possible ways in which rights management can be supported in conjunction with content protection.

Thus, many different models of content delivery and rights management, across different platforms, will need to be supported in the future.

### SUMMARY

The present invention addresses the foregoing need by providing a secure mechanism that allows support for various content right models, processing, and content decoding models, as well as other custom secured functionality, without requiring the inclusion of a priori support for those models and related processing in a device.

The rights management, or part of it, is incorporated with the help of secure snippets. Similarly, a specific decompression algorithm or part of it can be also secured with the help of secure snippets.

Secure snippets are fragments of code that are protected against reverse engineering and are downloaded separately or with content. They can be pushed into the device, accessed directly from the mobile device, or embedded with the content.

Secure snippets can be directly executing on a machine or supported with a virtual machine.

When used in conjunction with DRM, the secure snippets can express usage rights and can also help in enforcing such rights.

Secure snippets, in one embodiment, are embedded in the rights object itself. When a secure snippet is part of DRM ticket, the ticket is referred to as an Active Ticket.

A secure snippet can be made to have protection for a variety of security threats including software reverse engineering, differential binary analysis, and runtime attacks. It can also have built-in protection or be obfuscated in such a way, that it is protected against physical attacks and side-channel attacks such as power analysis, electromagnetic analysis, and fault injection. A secure snippet typically executes on a security processor or in a secure virtual machine emulating such execution.

In one embodiment, the Active Ticket can be represented as part of an XML description. This can be similar or based on an extension to the Open Mobile Alliance (OMA) defined DCF rights format. In this case, the embodiment can implement new functionality not present in OMA. In the same way, the Active Ticket can be used to emulate or extend other DRM standards.

In another embodiment, the Active Ticket can be used to implement arbitrary custom functionality without following the requirements of a standard. It can also be used to combine standard DRM, extending standard DRM, and to add new custom DRM in the same solution.

Because the Active Ticket contains the enforcing rights management, it does not require a priori built-in rights handling in the device. The DRM will instead be handled with either a security device capable of executing secure snippets or a software virtual machine similarly capable of executing the secure snippet.

Unless otherwise defined, all technical and scientific terms used herein have the same meaning as commonly understood by one of ordinary skill in the art to which this invention belongs. Although methods and materials similar or equivalent to those described herein can be used in practice or in the testing of the present invention, suitable methods and materials are described below. In addition, the materials, methods, and examples are illustrative only and are not intended to be limiting.

Other features and advantages of the invention will become apparent from the following description, including the claims and drawings.

### BRIEF DESCRIPTION OF THE DRAWINGS

FIG. 1 is a block diagram showing the typical layers in a mobile device for supporting DRM. The figure also shows the relationship between device and content provider, and the exchange of information between the various players involved in content delivery and rights enforcement.

FIG. 2 is a message flow-diagram showing the messages and their order exchanged typically between content provider, involved device, and rights issuer.

FIG. 3 shows an example permissions section in a DRM rights object expressed with the OMA (Open Mobile Alliance) REL (Rights Expression Language).

FIG. 4 shows an example of incorporating secure snippets or the rights enforcing code itself into an OMA REL standard to extend OMA or implement a different rights model. As mentioned, whenever a secure snippet is part of a ticket we refer to it as Active Ticket.

FIG. 5 shows an example of a secure snippet in a Virtual Instruction Set Computing (VISC) format. A VISC ode contains instructions of which encoding is randomly generated. A snippet based on VISC is a possible embodiment for creating Active Tickets or other rights enforcement codes.

In other embodiments, the VISC secure snippet code could be downloaded with the content, or embedded into the digital content, or downloaded separately. Other combinations might be possible.

### DESCRIPTION

In the embodiments described herein, we show how secure snippets, VISC based or other types, are used in Active Tickets implemented for enforcing rights management. Furthermore, they could be implementing services for enforcing content management and protection or protecting media players.

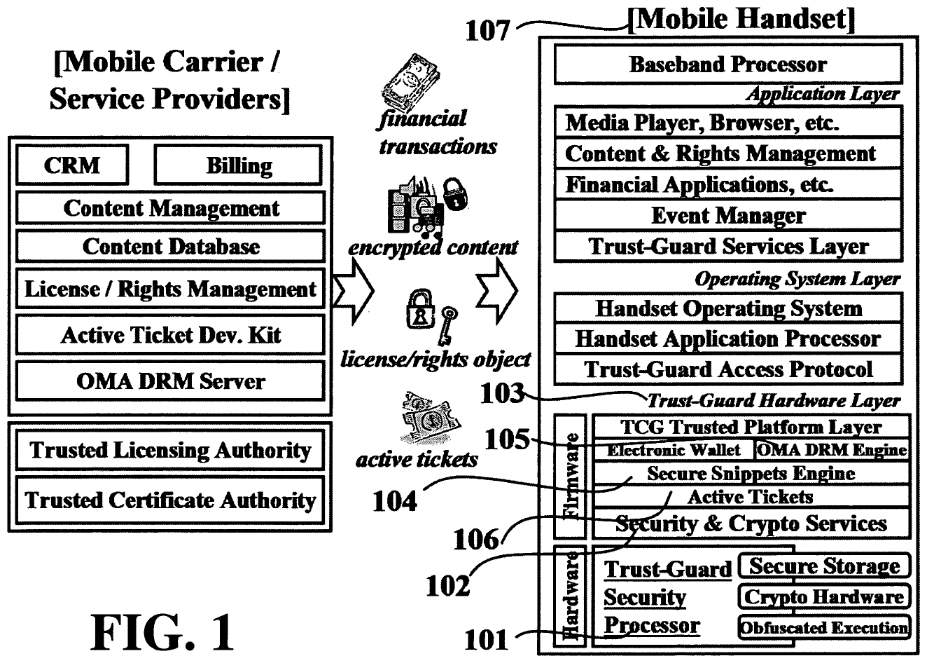

FIG. 1 shows a block diagram of the components of one embodiment based on VISC.

The main components include a VISC compliant security processor 101 built into the handset, the firmware support could include 103, 104, 105, and 106 to support security services, a DRM agent running on this processor or another application processor, support for secure execution of the snippets and enforcing active tickets technology, and using secure snippets to protect applications running on other processors in the handset.

101 shows the microprocessor called Trust-GUARD where snippets are executed. When the snippets are embedded into a media player they can be used to secure the media player by creating voids in the media player software that cannot be accessed in a conventional processor or reverse engineered. Such protection solution can be used separately or together with snippets enforcing rights to individual media.

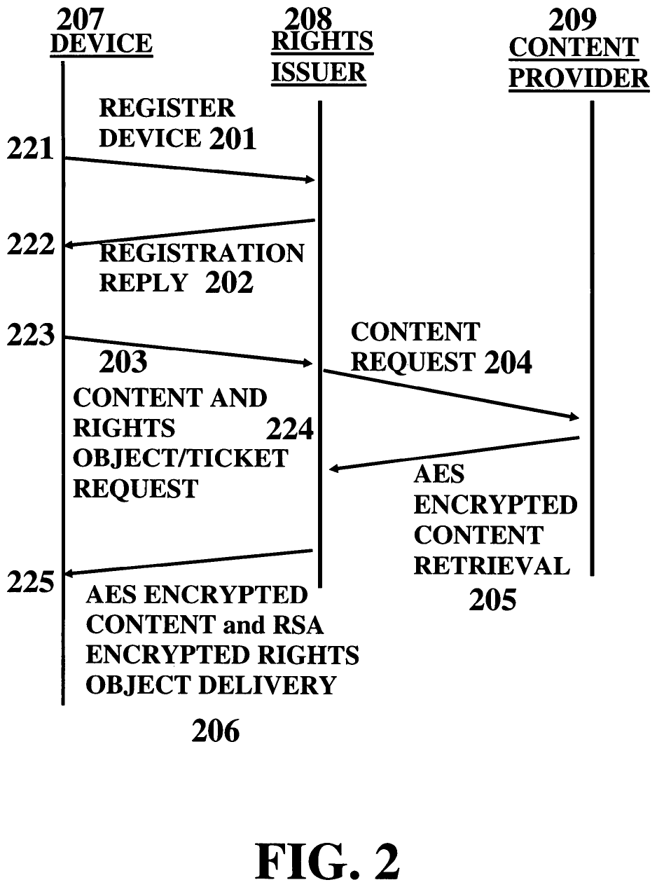

FIG. 2 shows a scenario of digital content delivery. It includes the main activities that take place between the handset device and (indirectly) the end user, the rights issuer, and content provider(s).

The following key phases shown on the figure take place:

Step 221: On device activation with the service provider (who can act as the root rights provider), the device (including the DRM agent in the device) would send its device serial number and a public key in message 201. The rights issuer would store this public key indexed by the device's serial number on their servers. The public key is created in a security processor and stored in protected persistent memory.

Step 222: The right's issuer would respond with the result of the registration (e.g. registration failed or succeeded) with message 202. The device is now ready to request content and rights objects.

Step 223: To retrieve some content (and associated rights object at the same time), the device sends a request 203 after agreeing to the method of payment/access through another presentation server.

Step 224: The rights issuer gathers the AES encrypted content and its respective AES key. The AES key is included in the active-ticket-enabled rights object and encrypted using the public key obtained in step 221.

Step 225: A package, in for example an OME DCF format, which includes the encrypted content and rights object, is delivered to the device in message 206. The rights objects contain secure snippets to enforce rights management or to provide other security benefits during playing the content.

We next show an example of a rights object without embedded processing capability.

### A Rights Object Example

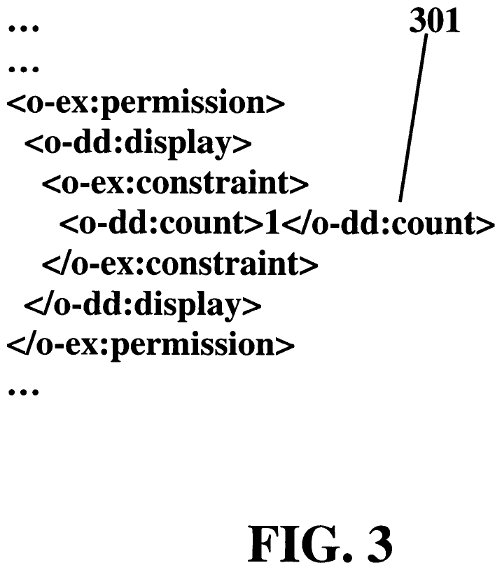

FIG. 3 shows an example permissions section in a rights object. This example is similar to a rights object, or ticket, defined by the OMA (Open Mobile Alliance) REL (Rights Expression Language) specification. Other encodings are also possible.

Its permission section would allow a user to preview some content by displaying it: in this example a single preview is allowed as shown in line 301. The object does not incorporate any processing capability to enforce this constraint. The enforcing of this capability would need to be present in the device. For example, an OMA-compliant DRM agent software must be residing in the handset for enforcing the rights.

An example of that was shown in FIG. 1 module 105 in the firmware. The embodiment in FIG. 1 could have used an approach solely based on secure snippet support 104 to enable DRM. The figure instead shows a scheme wherein both snippets based rights management enforcing and OMA DRM are supported. This is not intended to be limiting. Other combination of system configurations and other standard DRM are also possible.

Active Ticket based DRM can emulate a standard DRM or express custom DRM, as the enforcing of rights will be downloaded in conjunction with content access.

Embedding Secure Snippets into the Rights Object

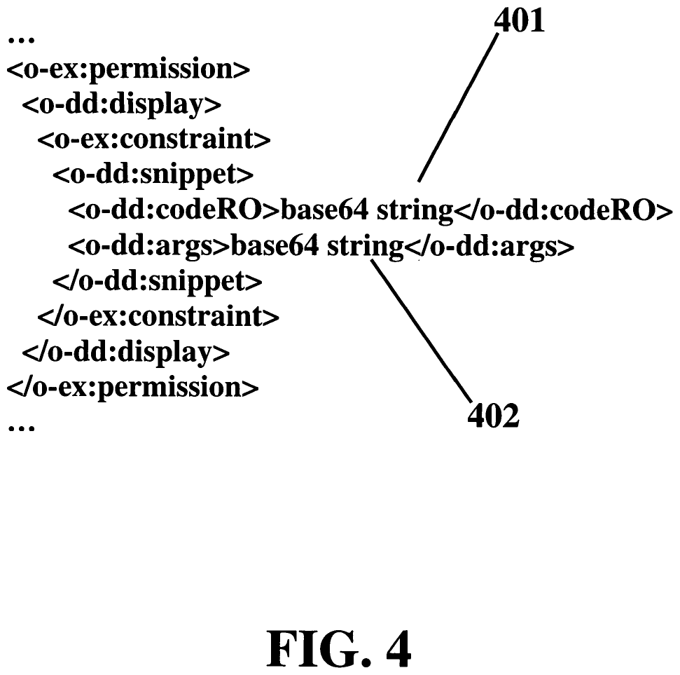

FIG. 4 shows how a secure snippet could be integrated into the existing OMA REL standard to provide the secured custom capability or service and as a mechanism to extend a standard DRM like OMA. This example shows one embodiment of the invention.

By adding the elements <snippet>, <codeRO> and <args>, a complete secure snippet could be defined and executed as a constraint in the permissions model. The lines required are shown as 401 and 402.

The <snippet> element would be a container for the <codeRO> and <args> elements. The <codeRO> element would contain a base64-encoded string (which can be interpreted into binary data by a parser in the device) that defines the read-only section of the snippet.

The <args> element would contain a similarly encoded string that would be converted into binary data and passed as an argument to the snippet. The argument could contain such information as the number of plays remaining, e.g., ‘1’ to mimic the preview example given above, or additional security values (e.g., encrypted hashes). Any changes to the arguments when the snippet finishes execution could be written back to the <args> section in the rights object. Integrity protection of the rights object and AES key delivery could be added.

By adding this support for snippet constraints, any of the current OMA defined DRM schemes could be implemented using a single snippet constraint. In addition, a future, constraint scheme could be developed without any modification required to the device-resident DRM agent, since the scheme's processing and information is included in the rights object under the <snippet> element.

The rights object does not have to be implemented with the RL format. It could contain just the rights enforcing itself and no other keywords, or could use other encoding.

Additional keys and hash values could be stored encrypted in the arguments section referred to as 402; these additional schemes could be developed and customized by content and rights providers as part of the snippet's code. FIG. 1 shows that a development environment for Active Tickets is provided to the enterprise or content/rights provider to develop secure snippets based DRM models.

The rights issuer is typically guaranteed that constraint processing is done securely, since the snippet is either encoded with VISC randomized instruction encoding or encrypted, and would be only executable on a secure architecture such as a security processor or a secure virtual machine.

### Content Decoding Related Secure Snippets

In addition to rights management, a secure snippet can be used for enabling custom media decoding. In one embodiment, this snippet is downloaded as part of a ticket. The media player residing in the device would only be able to decode the content if the snippet is correctly executed in the security processor or secure snippet virtual machine.

### Protection of Applications Using Secure Snippets

Mobile handsets often contain multiple processing engines or application processors. A secure snippet can be embedded into a binary of such an application processor to protect the application against piracy or illegal modification, and to protect critical intellectual property. These snippets would be encoding actual parts of the application functionality that needs to be protected.

The approach requires a security processor or an equivalent virtual machine to be present in the device supporting the execution of secure snippets. During runtime (for example, when running a media player that has embedded snippets) the snippets are communicated to the secure processor that executes them and returns data-dependent results.

The communication between an application processor and a security processor can be provided with a secure authentication mechanism such as defined by the Trusted Platform Module Standard from the Trusted Computing Group.

Because the application will not run without the security processor correctly executing these snippets, the media player cannot be copied or run on other devices illegally.

Because, integrity checking can be secured and checks stored securely with the help of secure snippets, protection can also be provided against illegal modification. Protection against replay attacks can be implemented by tying the snippets together in the security processor: removing a snippet would be the detected by another snippet.

### Secure Snippets

There are many possible embodiments for securing snippets. Snippets are code fragments executing on a secure processor with an encoding such as VISC or they could be encrypted. This includes encrypting code snippets with a symmetric cryptographic technique like AES.

Another approach is to have a processor that includes obfuscated execution and encoding of its instructions, wherein instruction encodings are randomized and tied together with security mutation instructions. The method is called VISC or Virtual Instruction Set Computing in this patent description.

VISC is based on a tightly integrated compiler-architecture framework. A compiler generates obfuscated code. Instruction encodings are randomly generated. To be able to decode, security instructions are added to the binary. These security instructions help chain the code together at runtime and are obfuscated or randomly encoded themselves. A key aspect of VISC is to communicate to processor execution engines how to un-scramble following instructions ahead of those instructions' decoding taking place.

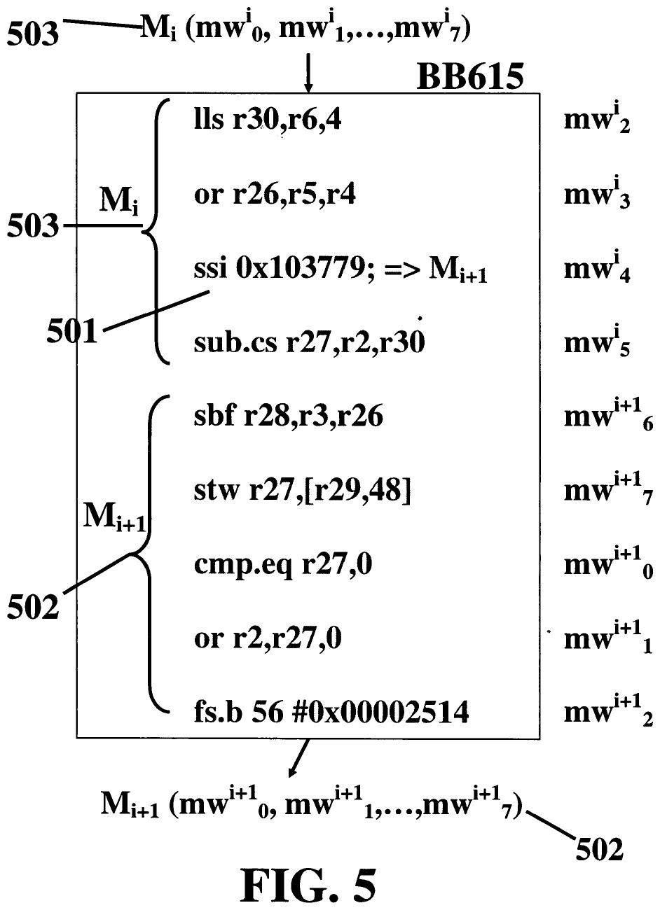

FIG. 5 shows an example of such VISC encoding. In the figure, shown for a basic block 615, there is an incoming instruction encoding template called Mᵢ. This template is randomly generated and possibly mutated randomly prior to this basic block. All instructions following in the BB615 are using the template when they are decoded unless the template is changed in the block.

The Mᵢ shown in the figure can be changed with inserted mutation instructions ssi referred to with 501. The region following the ssi instruction changes the encoding to Mᵢ₊₁ referred to as area 504.

This way, instructions can be having an encoding that is randomly created and encoding is continuously mutated whenever ssi instructions are encountered. The VISC code is generated and organized in such a way that decoding is made possible during execution. The mutation instructions, like ssi, are also randomly encoded. For example, ssi in the example is encoded with template Mᵢ.

There are many different types of mutation instructions possible. The example shown is not intended to be limiting. For example, there could be implicit mutations wherein encoding is automatically changing based on an event taking place. Or, there could be mutations based on register-based payloads as opposed to immediates.

Furthermore, a combination of techniques can also be applied such as in schemes using both VISC-based and encryption.

At runtime, once the configuration for a VISC code is available, the un-scrambling hardware is set to the specified scheme on-the-fly. Note that mutation instructions, like ssi in FIG. 5, would change that encoding; each encoding template has a very short lifetime after which it can be discarded.

Examples of mutations that can be supported include various bit permutations. Other more complex schemes can be easily derived. By decoupling the encoding of an instruction from the operation that it encodes, physical attacks that rely on that correlation, such as power analysis, can be prevented. Off-line attacks can be protected against, as instruction encodings are randomly generated.

Hardware support can be used to execute VISC codes depending on the embodiment. In one embodiment, the VISC decoding can be completed in a virtual machine fully implemented in software. In another embodiment, the machine itself can directly support this execution model.

When used to implement rights enforcing related processing, an initial key for the decoding template can be encapsulated and protected in a similar manner as the symmetric encryption key needed at destination to decrypt the content.

Both this key and a VISC key could be then protected by the public-secret key mechanism described in FIG. 2. In another embodiment, an initial configuration for a VISC secure snippet or Active Ticket could be downloaded with a secure authentication/authorization protocol such as defined by the TPM.

### Other Embodiments

The invention is not limited to the specific embodiments described herein. Other types of obfuscation can be used for securing snippets and combined with other techniques, in other embodiments. The secure snippets can be used to implement other types of custom security services or arbitrary functionality than described in the above embodiments. Other embodiments not described herein are also within the scope of the following claims.

What is claimed is:

1. A method of operating an electronic device comprising first circuitry and second circuitry that is different than the first circuitry, wherein the first circuitry includes a first processor, and wherein the electronic device is associated with a secure architecture to enforce a constraint of digital rights in media content, the method comprising:
receiving, by the electronic device, data comprising the media content and additional data comprising a DRM (digital rights management) ticket, wherein, embedded in the DRM ticket is code recoverable to identify a block for execution by a second processor of the second circuitry or a virtual machine that corresponds to instructions stored in a memory of the second circuitry to extend a content decoding capability of the electronic device in connection with content access by the first processor;
wherein the block comprises first instructions describing an instruction encoding template recoverable by only the second processor of the first and second processors, the first instructions preceding corresponding second instructions decodable using the instruction encoding template, wherein the second processor or virtual machine is VISC-based (virtual instruction set computing) and the second processor or virtual machine uses the instruction encoding template to discover a content decoding model, and wherein the content decoding capability of the electronic device is extended in response to the second processor or the virtual machine returning data obtained using the instruction encoding template; and
processing the code by the electronic device to enforce the constraint, wherein processing the code by the electronic device to enforce the constraint includes executing the block by the second processor or the virtual machine.

2. The method of claim 1, wherein the extended content decoding capability is a first custom decode capability that is different than a second content decoding capability enabled on the electronic device prior to a time of the content access.

3. The method of claim 1, further comprising communicating a result of the executing to the first processor, wherein the decoding capability of the electronic device is extended responsive to identification of the result by the first processor.

4. The method of claim 1, further comprising:
providing support, in the second processor, for DRM models in addition to enforcing the constraint.

5. The method of claim 1, wherein the DRM ticket comprises a REL (rights expression language) encoding.

6. The method of claim 1, further comprising:
issuing a request for the media content from the electronic device to an issuing authority.

7. The method of claim 1, wherein the code comprises a snippet, the snippet comprising an argument that is passed to, and written from, the block.

8. The method of claim 1, wherein the block contains one or more mutation instructions to randomly mutate the instruction encoding template one or more times to generate one or more additional instruction encoding templates, respectively, the one or more mutation instructions preceding corresponding one or more third instructions, respectively, the one or more third instructions decodable using the one or more additional instruction encoding templates, respectively, wherein the content decoding capability of the electronic device is extended in response to the second processor or the virtual machine returning data obtained using the instruction encoding template and the one or more additional instruction encoding templates;
wherein at least one of the one or more mutation instructions is encoded using the instruction encoding template.

9. An apparatus comprising:
an electronic device comprising first circuitry and second circuitry that is different than the first circuitry, wherein the first circuitry comprises a first processor, the electronic device configured to:
identify data that includes media content;
identify additional that includes a DRM (digital rights management) ticket;
wherein the electronic device is associated with a secure architecture to enforce a constraint of the digital rights; and
wherein embedded in the DRM ticket is the code recoverable to identify a block for execution by a second processor of the second circuitry or a virtual machine that corresponds to instructions stored in a memory of the second circuitry to extend a content decoding capability in connection with content access by the first processor;
wherein the block comprises first instructions describing an instruction encoding template recoverable by only the second processor of the first and second processors, the first instructions preceding corresponding second instructions decodable using the instruction encoding template, wherein the second processor or virtual machine is VISC-based virtual instruction set computing) and the second processor or virtual machine uses the instruction encoding template to discover a content decoding model, and wherein the content decoding capability of the electronic device is extended in response to the second processor or the virtual machine returning data obtained using the instruction encoding template; and
process the code to enforce the constraint, wherein process the code by the electronic device to enforce the constraint includes execute the block by the second processor or the virtual machine.

10. The apparatus of claim 9, wherein the code comprises a snippet, the snippet comprising an argument that is passed to, and written from, the block.

11. The apparatus of claim 9, wherein the extended content decoding capability is a first custom decode capability that is different than a second content decoding capability enabled on the electronic device prior to a time of the content access, and wherein the first custom decode capability is enabled after initiation of the content access.

12. The apparatus of claim 9, wherein the electronic device is configured to implement an authorization protocol with the object for communication between the first processor and the second processor or the virtual machine.

13. The apparatus of claim 9, wherein the electronic device is configured to issue a request for the media content to an issuing authority.

14. A memory having instructions stored thereon that, in response to execution by a processing device, cause the processing device to extend a content decoding capability of an electronic device in connection with a first processor of the electronic device accessing media content and using a second different processor of the electronic device or a virtual machine of the electronic device, the operations comprising:
generating a DRM (digital rights management) ticket, wherein embedded in the DRM ticket is code recoverable to identify a block comprising first instructions describing an instruction encoding template recoverable by only the second processor of the first and second processors, the first instructions preceding corresponding second instructions decodable using the instruction encoding template, wherein the instruction encoding template is executable by the second processor or the virtual machine to discover a content decoding model, and wherein instruction encoding template is further executable to return data to extend the content decoding capability; and
transmitting the DRM ticket over a network.

15. The memory of claim 14, wherein the code comprises a snippet, the snippet comprising an argument to be passed to, and written from, the code responsive to processing the code.

16. The memory of claim 14, wherein transmitting the DRM ticket over the network further comprises transmitting the DRM ticket over the network to the electronic device.

17. The memory of claim 14, wherein the extended content decoding capability is a first custom decode capability that is different than a second content decoding capability enabled on the electronic device prior to a time of the accessing.

18. The memory of claim 14, wherein the DRM ticket comprises a REL (rights expression language) encoding.

19. The memory of claim 14, wherein the operations further comprise transmitting the DRM ticket responsive to receiving over the network a request for the media content.

20. A method, comprising:
identifying data that includes media content;
generating a DRM (digital rights management) ticket in connection with a first processor of an electronic device accessing the media content, wherein embedded in the DRM ticket is code executable by a second different processor of the electronic device or a virtual machine of the electronic device an electronic device of a secure architecture to enforce a constraint of the digital rights and to extend a content decoding capability of the electronic device;
wherein the code is recoverable to identify a block comprising first instructions describing an instruction encoding template recoverable by only the second processor of the first and second processors, the first instructions preceding corresponding second instructions decodable using the instruction encoding template, wherein instruction encoding template is executable by the second processor or the virtual machine to discover a content decoding model, and wherein instruction encoding template is further executable to return data to extend the content decoding capability; and
transmitting the DRM ticket over a network.

21. The method of claim 20, further comprising implementing an authorization protocol with the DRM ticket for communication between the second processor or the virtual machine and the first processor.

22. The method of claim 20, further comprising executing the block on the electronic device, wherein the electronic device comprises a digital media viewer, the digital rights being used for security purposes.

23. The method of claim 20, further comprising:
accessing the code using the electronic device to enforce the constraint; and
providing support, in the second processor or the virtual machine, for digital rights management (DRM) models in addition to enforcing the constraint.

24. The method of claim 20, wherein the code comprises a snippet, the snippet comprising an argument to be passed to, and written from, the code responsive to processing the code.

25. The method of claim 20, wherein the DRM ticket comprises a REL (rights expression language) encoding.
